(19) United States
(12) Patent Application Publication
(10) Pub. No.: US 2017/0282178 A1
(43) Pub. Date: Oct. 5, 2017

(54) PORTABLE QPCR AND QRT-PCR APPARATUS

(71) Applicant: Credo Biomedical Pte Ltd., Singapore (SG)

(72) Inventors: Jr Winston WONG, New Taipei City (TW); Stephen, Chang-Chi KAO, New Taipei City (TW); Ying-Ta Lai, New Taipei City (TW); Ming-Fa Chen, New Taipei City (TW); Chih-Rong Chen, New Taipei City (TW)

(21) Appl. No.: 15/470,918

(22) Filed: Mar. 28, 2017

Related U.S. Application Data
(60) Provisional application No. 62/315,660, filed on Mar. 30, 2016.

(51) Int. Cl. B01L 3/00; B01L 7/00; G01N 21/64

(52) U.S. Cl. CPC B01L 3/50273; G01N 21/6428; B01L 7/52; G01N 2021/6439; B01L 2300/0663; B01L 2300/08; B01L 2400/0469; B01L 2300/0654; B01L 2300/0681

(57) ABSTRACT

The present invention is related to a portable apparatus for performing uni-directional convective qPCR or qRT-PCR in a mixing reagent containing a target nucleic acid and a fluorescence dye including denaturation, annealing and extension processes. The apparatus includes at least a temperature controlling unit which comprises at least one heat source and one temperature sensor, a circulation-enabling container, a light source, a photo-detector, a filter, a set of optical elements, and a processor.

### CROSS REFERENCE TO RELATED APPLICATIONS

This application claims the benefit of priority of U.S. Provisional Application No. 62/315,660 filed on Mar. 30, 2016, and included herein by reference.

### BACKGROUND OF THE INVENTION

### 1. Field of the Invention

This invention is related to a quantitative real-time polymerase chain reaction (hereinafter qPCR) and quantitative reverse transcription real-time PCR (hereinafter qRT-PCR) apparatus by a uni-directional convective circulation.

### 2. Description of the Prior Art

The real-time quantitative polymerase chain reaction (hereinafter qPCR) and the quantitative reverse transcription real-time PCR (hereinafter qRT-PCR) were developed based on the need for quantifying target at time₀, during and after a test. Compared to traditional PCR which detects product concentration after the reaction, qPCR and qRT-PCR detect it real-time. Both qPCR and qRT-PCR use fluorescence to detect and quantify the product concentration during the reaction, and thus they are more time effective than traditional PCR. Moreover, both qPCR and qRT-PCR allow for complete reaction and detection within one test zone. Therefore, the advantages of qPCR and qRT-PCR are quantifying products in real-time and minimizing the chance of DNA contamination where PCR products are analyzed by gel electrophoresis.

For fast and efficient amplification of various targets, lots of apparatuses and methods were developed. The developing principles of these apparatuses and methods are still following the basic PCR rules. In the commercialized PCR kits, methods, and related apparatuses, a sample contained a target DNA, a pair of oligonucleotide primers which are complementary to a specific region of the target DNA, a DNA polymerase which is thermally stable, and deoxynucleotide triphosphates (dNTP). The target DNA is amplified by repeating a designated temperature cycle that sequentially changes the heating temperature of the sample. The temperature cycle includes three different temperature settings, and the temperature settings are set for the following steps.

The first step is so-called “denaturation” in which the temperature is about 90-95° C. The sample is heated to a relatively high temperature to let a double stranded DNA (hereinafter dsDNA) become a single stranded DNA (hereinafter ssDNA). The second step is so-called “annealing” in which the temperature is decreased to a relative low temperature, that is, about 45 to 65° C., to let the primers bind to the single stranded DNA and form a primer-ssDNA complex. The last step is so-called “extension” in which the temperature is heated or maintained at a suitable temperature, that is 72° C., to let the primer of the primer-ssDNA complex extend by the action of the DNA polymerase to generate a new ssDNA complementary to the template of the target DNA, thus to generate new dsDNA products. Theoretically, the target DNA can be amplified millions or higher number of copies by repeating the three steps for about 20 to 40 times.

In qPCR or qRT-PCR, the addition of dsDNA fluorescence dyes is prepared as usual. Then the reaction is run in a qPCR instrument, and after each cycle, the intensity of fluorescence is measured with a photo-detector. Two common methods for quantifying the PCR or RT-PCR products in real-time are: (1) non-specific fluorescence dyes that intercalate with any dsDNA, and (2) sequence-specific DNA probes consisting of oligonucleotides that are labelled with a fluorescent reporter which permits detection only after hybridization of the probe with its complementary sequence. Both qPCR or qRT-PCR are carried out in a repeating temperature cycle with the capacity to illuminate each sample with a beam of light of at least one specified wavelength and detect the fluorescence emitted by the excited fluorophore.

If the non-specific fluorescence dyes added to the PCR bind to the dsDNA, the increase of the products during PCR would lead to an increase in fluorescence intensity measured at each cycle. However, dsDNA dyes such as SYBR® Green will bind to all dsDNA PCR products, including nonspecific PCR products (such as primer dimer). This can potentially interfere with the accuracy of the quantification of the PCR products. If the sequence-specific DNA probes are added to the PCR, the fluorescent reporter probes detect only the DNA containing the sequence complementary to the probe; therefore the use of sequence-specific fluorescence dye significantly increases specificity, and enables performing the technique even in the presence of other dsDNA. The advantage of sequence-specific fluorescence dyes is that it can prevent the interference of measurements caused by primer dimers.

Typically, the qPCR and qRT-PCR apparatus are large bench top systems that require long reaction time (over 1 hour) because qPCR and qRT-PCR requires a mechanism that cycles through three different temperature ranges allowing for denaturation, annealing and elongation of the target DNA segments. In order to achieve such requirement, qPCR and qRT-PCR apparatus may be of significant weight and size, and also require significant amount of testing time, thus such apparatus eliminates its portability.

### SUMMARY OF THE INVENTION

To solve this problem, the present invention discloses a portable uni-directional circulating liquid flow which allows q-PCR and qRT-PCR reaction to take place within a circulation-enabling container by thermal convection. This present invention comprises at least a temperature controlling unit which comprises at least one heat source and one temperature sensor, a circulation-enabling container, alight source, a photo-detector, a filter, a set of optical elements, and a processor. The foresaid components are not limited to any particular arrangement or order.

The circulation-enabling container comprises at least one opening, a closed-loop system, and a pathway connected from end to end which allows for the mixing reagent to flow through different zones of the circulation-enabling container in one cycle.

The qPCR and qRT-PCR reagents are poured into the circulation-enabling container when the reaction begins and the circulation-enabling container is placed and contacted to the heat source with a specific region. The circulation-enabling container could be symmetric or asymmetric. When the temperature of the contacted region of the circulation-enabling container increases to the reaction temperature of denaturation, the mixing reagent close to the contacted region would be heated first, and the mixing reagent far from the heat source would be heated thereafter. The density of the mixing reagent closer to the heat source would be lower than the density of the mixing reagent further away from the heat source; with the effect of gravity and buoyancy, a continuous uni-directional circulating flow is created. When the temperature inside the circulation-enabling container reaches the reaction point by aforesaid thermal convection, the PCR reaction is initiated. Without spending time on heating and/or cooling the thermal device for the three different reaction temperatures, the present invention discloses an embodiment of three different temperature zones allowing for denaturation, annealing and elongation of PCR inside the circulation-enabling container with at least one heating source, thus saving reaction time and apparatus size simultaneously.

This SUMMARY is provided to briefly identify some aspects of the present disclosure that are further described below in the DESCRIPTION. This SUMMARY is not intended to identify key or essential features of the present disclosure nor is it intended to limit the scope of any claims.

The term “aspects” is to be read as “at least one aspect.” The aspects described above and other aspects of the present disclosure described herein are illustrated by way of example (s) and not limited in the accompanying drawing.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

A more complete understanding of the present disclosure may be realized by reference to the accompanying drawings in which:

FIG. 1 is a schematic diagram illustrating the first configuration of a qPCR and qRT-PCR of the present disclosure;

FIG. 2 is a schematic diagram illustrating the U-shaped loop of the first configuration;

FIG. 3 is a schematic diagram illustrating temperature gradient inside the U-shaped loop during the reaction of the first configuration;

FIG. 4 is a schematic diagram illustrating a second configuration of a qPCR and qRT-PCR of the present disclosure;

FIG. 5 is a schematic diagram illustrating the U-shaped loop of the second configuration;

FIG. 6 is a schematic diagram illustrating a third configuration of a qPCR and qRT-PCR of the present disclosure;

FIG. 7 is a schematic diagram illustrating the U-shaped loop of the third configuration.

### DETAILED DESCRIPTION

This present invention comprises at least a temperature controlling unit which comprises at least one heat source and one temperature sensor, a circulation-enabling container, a light source, a photo-detector, a filter, a set of optical elements, and a processor. The foresaid components are not limited to any particular arrangement or order.

The circulation-enabling container comprises at least one open, a closed-loop system, and a pathway connected from end to end which allows for the mixing reagent to flow through different zones of the asymmetric circulation-enabling container in one cycle. The circulation-enabling container could be asymmetric or symmetric based on the experimental requests. The circulation-enabling container could be a U-shaped loop, a cube, or other structures.

The temperature controlling unit comprises a heat source for supplying the heat and a temperature sensor for detecting the status of the heat source. The temperature controlling unit is placed and contacted in a specific region in the circulation-enabling container. The temperature controlling unit is configured to adjust the temperature inside of the circulation-enabling container for reaction temperature and flow field distribution. It is possible to use one or more temperature controlling units in different conditions.

The symmetry of the circulation-enabling container is a key factor to drive and initiate a uni-directional circulation liquid flow by the effect of gravity and buoyancy, and so does the contacted region between the circulation-enabling container and the heat source. The number of heat source (s) is also a key factor. Each of them could cause a uni-directional circulation inside the circulation-enabling container independently or corporately.

One may further limit the direction of flow of the liquid inside the circulation-enabling container by placing one or more heat sources in the specific regions to control thermal and buoyancy conditions that favor one flow direction over other direction(s). For example, instead of using one heat source on the bottom, the container can be heated at a region off center. In one embodiment described below, using two set of temperature controlling units which are placed in different height from the bottom of the circulation-enabling container can also reach the same outcome.

The light source is a specific wavelength of light system, such as a LED, a laser diode, or a halogen light. The fluorescence is light emission by a substance that has absorbed the light source. A substance could absorb such light and emit a fluorescent signal which could then be used for monitoring the reaction status. The photo-detector is configured to convert the optical signals to electronic signals. The photo-detector could be a single unit such as a photomultiplier zone (hereinafter PMT), photodiodes, or a photo-detector array, for example a charge-coupled device (hereinafter CCD) or a complementary metal-oxide-semiconductor (hereinafter CMOS).

The processor is configured to receive and analyze the electronic signals which are transferred from the temperature sensor, photo-detector or the photo-detector array. The filter is configured to filter out these non-predetermined wavelengths of the light sources and let the predetermined wavelengths pass through the filter. One can use one or more optical elements such as a lens or an optical fiber to direct the filtered or unfiltered fluorescent signal to the photo-detector.

The present invention provides a continuously uni-directional circulating liquid flow to allow the PCR or RT-PCR to react within the circulation-enabling container by thermal convection. Such circulation-enabling container facilitates the uni-directional liquid flow by providing pathway connected from end to end which allows for the reagent to flow through different thermal zones in one cycle and limiting the possible flow paths for predictable reaction efficiency. The thermal convection of the liquid is driven by buoyancy and gravity. When the temperature inside the circulation-enabling container increases to the reaction point by aforesaid thermal convection, the flow of liquid begins and PCR reaction is initiated. And the temperature sensor transfers this status to the processor to initiate the following process. The presence of PCR products will interact with fluorescence dye and fluorescent signal would be emitted and detected by the photo-detector. A programmed algorithm is built into the processor to analyze the fluorescent signal to quantify the PCR or RT-PCR in real-time.

In one embodiment described below, it is possible to further limit the direction of the flow path by designing an asymmetric pathway connected from end to end of the circulation-enabling container. The angle of one end of the pathway is different from that of the other end, which leads to a different vertical height between these two ends. When the temperature controlling unit starts to provide heat in the contacted region, the density of the mixing reagent closer to the contacted region is lower than the mixing reagent away from the contacted region, thus to lead a buoyancy gap inside the reagent and to initiate a uni-directional circulation liquid flow by the effect of gravity and buoyancy.

The following merely illustrates the principles of the disclosure. It will thus be appreciated that those skilled in the art will be able to devise various arrangements which, although not explicitly described or shown herein, embody the principles of the disclosure and are included within its spirit and scope.

Furthermore, all examples and conditional language recited herein are principally intended expressly to be only for pedagogical purposes to aid the reader in understanding the principles of the disclosure and the concepts contributed by the inventor(s) to furthering the art, and are to be construed as being without limitation to such specifically recited examples and conditions.

Moreover, all statements herein reciting principles, aspects, and embodiments of the disclosure, as well as specific examples thereof, are intended to encompass both structural and functional equivalents thereof. Additionally, it is intended that such equivalents include both currently known equivalents as well as equivalents developed in the future, i.e., any elements later developed that perform the same function, regardless of structure.

Unless otherwise explicitly specified herein, the drawings are not drawn to scale.

We now provide some non-limiting, illustrative examples that illustrate operational aspects of a mixing device and associated method preparing materials used in biological or biochemical assays.

As used herein, directional terms as may be used such as “horizontal,” “vertical,” “proximal,” “distal,” “front”, “rear”, “left,” “right,” “inner,” “outer,” “interior” and “exterior” relate to an orientation of the disclosed apparatus from the perspective of a typical user, and do not specify permanent, intrinsic features or characteristics of the device.

As used in below three embodiments, the circulation-enabling container is unified by U-shaped loop.

As used herein, the positional relationship and related terms as may be used such as “before”, “after”, “front”, and “rear” relate to an order of arrival of a reflected light beam traveling among the elements of the disclosed apparatus of each of the embodiments of the invention. For instance, an U-shaped loop is the first element that reflected light beam, and the U-shaped loop is located in the rearmost position of each of the disclosed apparatus.

### Embodiment 1

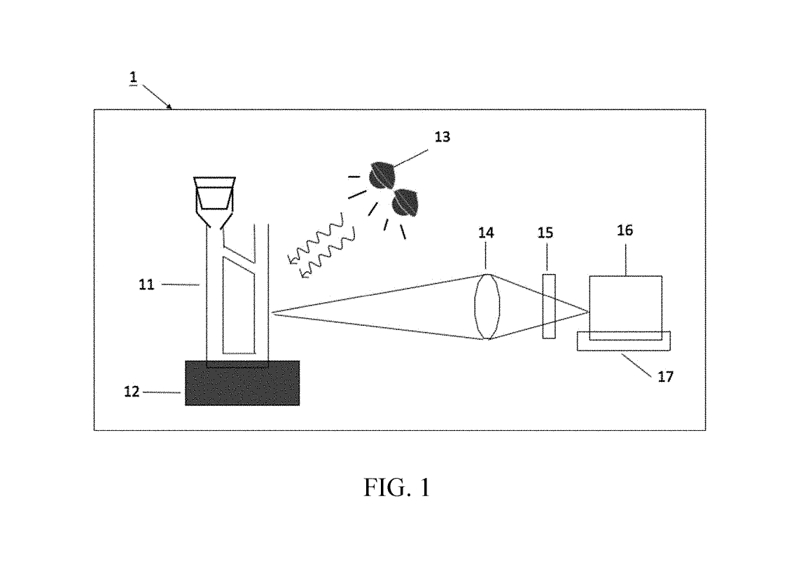

As illustrated in FIG. 1, the q-PCR and qRT-PCR device 1 comprises a temperature controlling unit, which is a heat source and a temperature sensor 12 in this embodiment, and a circulation-enabling container, which is a U-shaped loop 11 in this embodiment. A light source 13, a photo-detector 16, a filter 15, a lens 14, and a processor 17 are also shown in the FIG. 1.

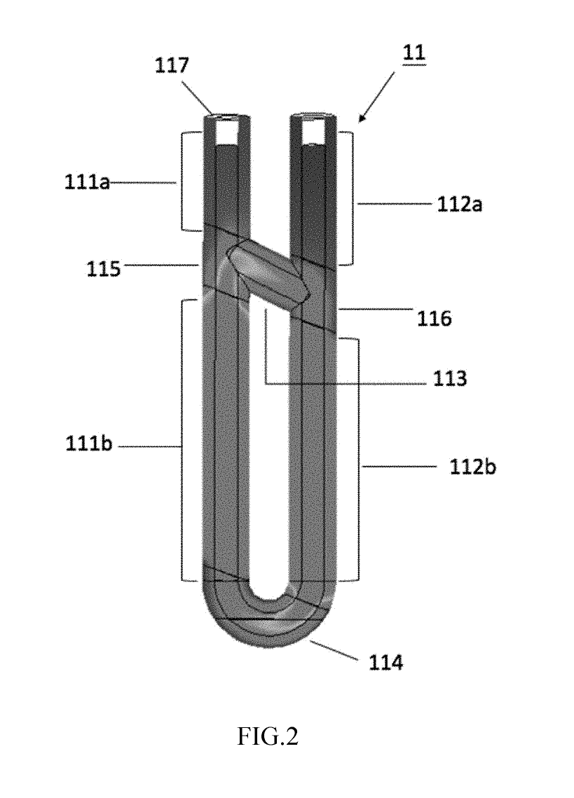

As shown in FIG. 2, the asymmetric circulation-enabling container is a U-shaped loop 11 with a pathway at different vertical height between the two ends of the U-shaped loop 11 forming a loop pathway. The U-shaped loop 11 has a left zone 111, a right zone 112, a link zone 113, and a bottom zone 114. The left and right zone 111,112 are perpendicular to the ground, and there is an opening 117 on the top of the left zone 111. The link zone 113 is connecting the left and right zone 111, 112 with a predetermined angle. In this embodiment, the left end of the link zone 113 is higher than the right end thereof. Furthermore, the left zone 111 can be distinguished from a left junction 115 as a left-upper zone 111a and a left-lower zone 111b. The right zone 112 can be distinguished from a right junction 116 as a right-upper zone 112a and a right-lower zone 112b. The bottom zone 114 connecting to the left zone 111 and the right zone 112 is a bending zone with symmetrical shape and a predetermined curvature radius. The bottom zone 114 of the U-shaped loop 11 is where the heat source and the temperature sensor 12 contact the surface of the U-shaped loop 11, and the U-shaped loop 11 is substantially perpendicular to the ground. In this invention, the inner diameter of the left zone 111, the right zone 112, the link zone 113, and the bottom zone 114 of the U-shaped loop 11 is between 0.6 mm to 1.6 mm, and inside the U-shaped loop 11 is a connected space for accommodating the solution. In this embodiment, the inner diameter of the U-shaped loop 11 is 1.6 mm, and the total volume of the solution in the U-shaped loop 11 is 150 μl. When the heat source and a temperature sensor 12 provide heat to the U-shaped loop 11 and make the temperature of the U-shaped loop 11 to a predetermined reaction temperature, the structure of the U-shaped loop 11 is capable of allowing a solution therein to flow in a uni-direction and form a flow field.

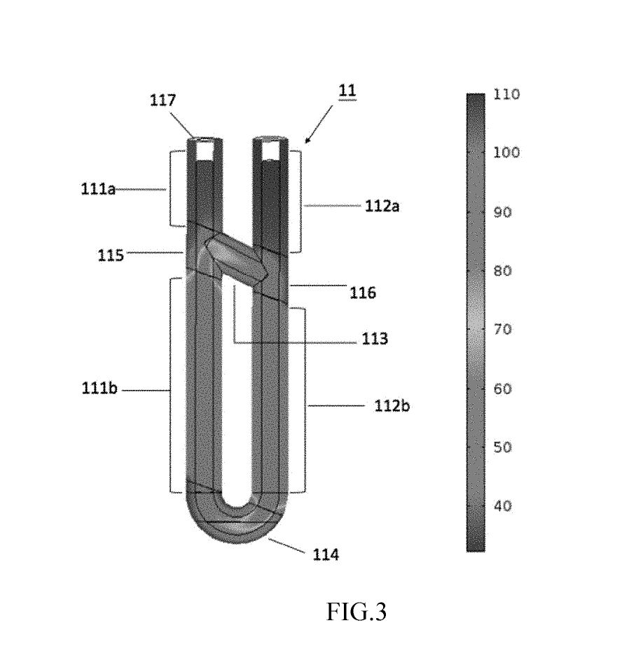

When the heat source and the temperature sensor 12 start to provide heat, the liquid of the bottom zone 114 would be first heated. The left zone 111 and the right zone 112 are both heated from the bottom to the top of the loop. The temperature of the left junction 115 is lower than the temperature of the right junction 116 due to the height of the left junction 115 is shorter than the height of the right junction 116. Therefore, the density of the left junction 115 is higher than the density of the right junction 116. The liquid of the left junction 115 flows to the right junction 116 by the effect of buoyancy, and thus the liquid of the right junction 116 pushes downward and back to the left junction 115, to initiate a clockwise uni-directional circulating flow. The temperature differentiation is as shown in FIG. 3, the higher temperature region inside the U-shaped loop 11 is the left-lower zone 111b, and the lower temperature region inside the U-shaped loop 11 is the right-lower zone 112b. In the embodiment, the heat source and a temperature sensor 12 is set in the range between 90-110° C. The temperature distribution during the reaction is described as below: the temperature of the left-upper zone 111a is between 30-40° C., the temperature of the left-lower zone 111b is between 90-100° C., the temperature of the right-upper zone 112a is between 30-40° C., the temperature of the right-lower zone 112b is between 45-60° C., and the temperature of the bottom zone 114 is between 60-90° C. The speed of uni-directional circulating flow is about 1.7-6 mm/s and it takes 10-33 seconds for one cycle.

The 150 μl solution comprises 30 μl primer (Canine-GAPDH_7-2-F′-GTGGATCTGACCTGCCGCCTGGAGAAAGCT-, 0.5 μM, 15 μl; and Canine-GAPDH_7-2-R′-CCTCAGTGTAGCCCAGGATGCCTTTGAGGG-, 0.5 μM, 15 μl), 75 μl of 2× mastermix (SensiFASTSYBR™ No-ROX, including dNTPs, DNA polymerase, SYBR™ Green), 3 μl plasmid DNA (3*10³ copies), and 42 μl secondary sterile water. SYBR™ Green is one kind of the fluorescent substances. In this embodiment, the fluorescent substance, which is loaded into the U-shaped loop, will interact with the amplicon and emit fluorescent signal when it is excited by the light source. By measuring this fluorescent signal, we can measure the concentration of amplicon real time.

The light source 13, such as LED lights, laser diode lights, or halogen lights, may emit a light beam with predetermined wavelength for a fluorescence excitation. The region where the light source 13 is deployed has a predetermined distance and angle of depression with respect to the U-shaped loop 11. The left zone 111, right zone 112, link zone 113, and bottom zone 114 have substantially the same irradiation intensity. Besides, the fluorescent substance enters the excited status as receiving the light beam, and exits the excited status with emitting fluorescent. In this embodiment, the light source 13 is a LED light and the wavelength thereof is between 450 to 490 nm, and the SYBR™ Green has max fluorescent value between 510 to 530 nm as excited by the light source with 450 to 490 nm wavelength.

The lens 14 is disposed in front of the U-shaped loop 11 at a predetermined distance, and at the same side as the light source 13 with respect to the U-shaped loop 11. The lens 14 is configured to receive the light beam reflected from the U-shaped loop 11. Besides, each of the distance between the lens 14 and the left zone 111, the right zone 112, the link zone 113, and the bottom zone 114 is substantially the same. The lens 14 is configured to refract a light beam and focus the light beam on the photosensitive unit to form an image of the U-shaped loop 11.

The filter 15 is disposed in the front of the lens 14 at a predetermined distance for receiving the light beam from the lens 14. In other words, the lens 14 is placed between the filter 15 and the U-shaped loop 11.

The photo-detector 16 is configured for converting the collected light signal to electrical signal receiving from the filter 15. The electrical signal is processed by a processor for analysis. In the invention, the photo-detector 16 can be a single element, such as a photomultiplier tube or a photodiode. The photo-detector 16 can also be an array, such as a charge-coupled device or a complementary metal-oxide-semiconductor. In the embodiment, the photo-detector 16 is a CCD.

### Embodiment 2

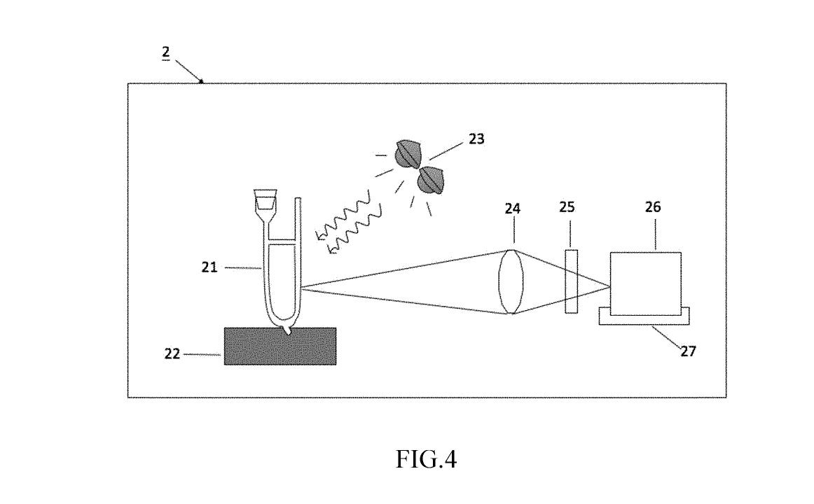

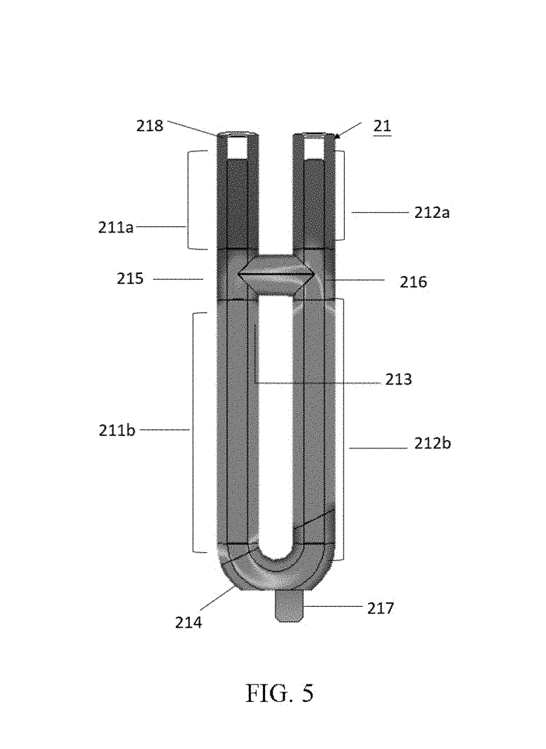

Referring to FIG. 4 and FIG. 5, a q-PCR and qRT-PCR apparatus 2 includes a temperature controlling unit, that is a heat source and a temperature sensor 22 in this embodiment, and a circulation-enabling container, which is U-shaped loop 21. A light source 23, a photo-detector 26, a lens 24, a filter 25, and a processor 27 are also shown in the FIG. 4 and FIG. 5. The connection and region of the light source 23, the photo-detector 26, the lens 24, the filter 25, and the processor 27 are substantially the same as described in FIG. 1. However, the connection and the region of the U-shaped loop 21 and the heat source and a temperature sensor 22 are different from FIG. 1.

When the heat source and a temperature sensor 22 provide heat to the U-shaped loop 21, the asymmetric structure of the U-shaped loop 21 is capable of allowing a solution therein to flow in a uni-directional way and form a flow field. As shown in FIG. 5, the U-shaped loop 21 has a left zone 211, a right zone 212, a link zone 213, a bottom zone 214, and a protruded zone 217 which is connected to the bottom zone 214. The left and right zones 211, 212 are perpendicular to the ground, and there is an opening 218 on the top of the left zone 211. The link zone 213 is connecting the left and right zones 211, 212. Besides, the angle of both the left junction 215 and the right junction 216 of the link zone 213 is parallel to the ground. In the embodiment, the left end of the link zone 213 is at the same height as the right end thereof. Furthermore, the left zone 211 can be distinguished from a left junction 215 as a left-upper zone 211a and a left-lower zone 211b. The right zone 212 can be distinguished from a right junction 216 as a right-upper zone 212a and a right-lower zone 212b. The bottom zone 214 interconnected between the left zone 211 and the right zone 212 is a bending zone with symmetrical shape and a predetermined curvature radius. The protruded zone 217 of the U-shaped loop 21 is where the heat source and a temperature sensor 22 contacts with the U-shaped loop 21. The protruded zone 217 would transfer the heat from heat source and a temperature sensor 22 to the U-shaped loop 21 during the reaction. In this embodiment, the protruded zone 217 is placed on the right of the bottom zone 214. The diameter, the solution volume, and the solution content are substantially the same as described in FIG. 1.

When the heat source and a temperature sensor 22 start to provide heat, the protruded zone 217 would be first heated and then the heat is transferred to the left zone 211 and the right zone 212. The temperature rises faster in the right zone 212 than the left zone 211 since the heat source and a temperature sensor 22 and the protruded zone 217 are closer to the right zone 212. When the solution nearby the bottom of right zone 212 was heated, the volume of the solution is expanded and the density is decreased. The heated liquid rises up near to the right junction 216 by the effect of buoyancy, and vacated volume would be supplemented by the surrounding liquid. When the supplement liquid is also raised up by the effect of buoyancy, the liquid near to the right junction 216 flows to the left junction 215 and back to the bottom of the right zone 212, to initiate a counterclockwise uni-directional circulating flow. The higher temperature region inside the U-shaped loop 21 is the left-lower zone 212b, the lower temperature region inside the U-shaped loop 21 is 211b. In the embodiment, the heat source and a temperature sensor 22 is set in the range between 90-110° C. The temperature distribution during the reaction is described as below: the temperature of the left-upper zone 211a is between 30-40° C., the temperature of the left-lower zone 211b is between 45-60° C., the temperature of the right-upper zone 212a is between 30-40° C., the temperature of the right-lower zone 212b is between 90-100° C., and the temperature of the bottom zone 214 is between 60-90° C. The speed of uni-directional circulating flow is about 1.7-6 mm/s and it takes 10-33 seconds for one cycle.

As nucleic acid amplification takes place, the fluorescent substance, which is loaded into the U-shaped loop, will interact with the amplicon and emit fluorescent signal when it is excited by the light source. The fluorescence is focused by the lens 24 and then passing through the filter 25 to filter out the non-predetermined wavelengths. In this embodiment, the emitted fluorescence signal with a wavelength 510-530 nm is detected by the CCD 26 and then the optical signals are converted to the electronic signals. The processor 27 analyzes the electronic signals. Therefore, this invention could real-time monitor the product concentration.

### Embodiment 3

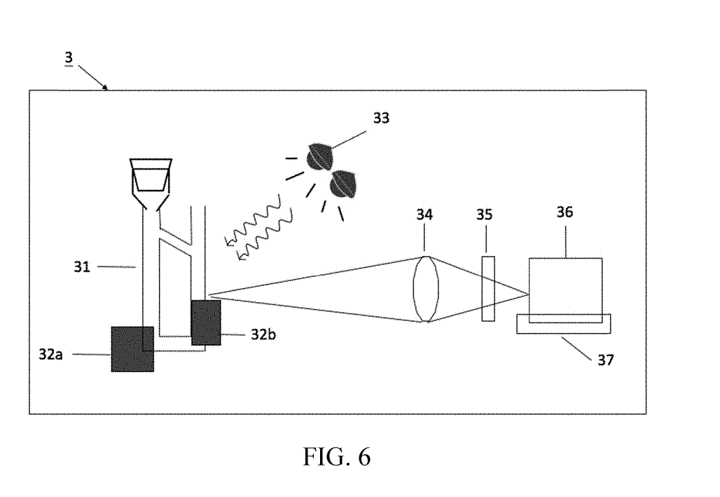

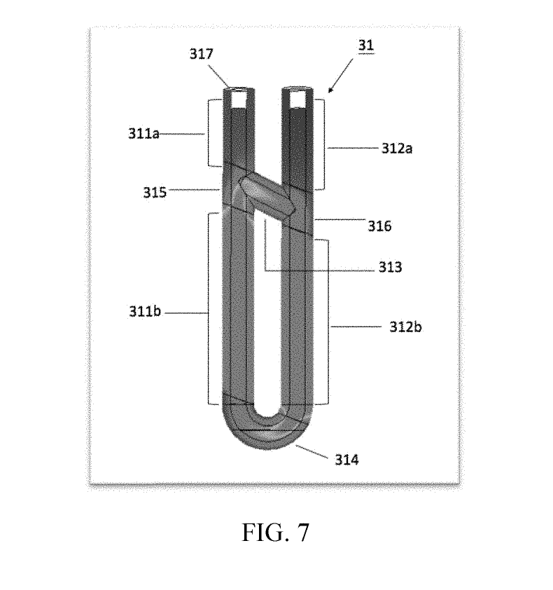

Referring to FIG. 6 and FIG. 7, a q-PCR and qRT-PCR apparatus 3 includes two sets of temperature controlling units, that are heat sources and temperature sensors 32a and 32b in this embodiment, a circulation-enabling container, that is U-shaped loop 31, a light source 33, a photo-detector 36, a lens 34, a filter 35, and a processor 37. The connection and region of the light source 33, the photo-detector 36, the lens 34, the filter 35, and the processor 37 are substantially the same as described in FIG. 1. However, the connection and the region of the U-shaped loop 31 and the heat sources and temperature sensors 32a and 32b are different from FIG. 1.

The heat sources and temperature sensors 32a and 32b could be defined as relatively higher heat source and temperature sensor 32a and relatively lower heat source and temperature sensor 32b. The preferred placement of both is the height of the relatively higher heat source and temperature sensor 32a being lower than the height of the relatively lower heat source and temperature sensor 32b. The predetermined temperature of the relatively higher heat source and temperature sensor 32a is between 90-120° C. and 5-30° C. for the relatively lower heat source and temperature sensor 32b. In this embodiment, the relatively higher heat source and temperature sensor 32a are placed in the junction of left zone 311 and bottom zone 314, while the relatively lower heat source and temperature sensor 32b are placed on the right zone 312 and the height of the relative higher heat source and temperature sensor 32a is lower than the height of the relatively lower heat source and temperature sensor 32b.

When the relatively higher heat source and temperature sensor 32a and the relatively lower heat source and temperature sensor 32b start to heat, the contact surfaces of the U-shaped loop 31 are first heated. The temperature rises faster in the left zone 311 than the right zone 312. When the solution nearby the contact surfaces of the U-shaped loop 31 and the relatively higher heat source and temperature sensor 32a was heated, the volume of the solution is expanded and the density is decreased. The heated liquid rises up near to the left junction 315 by the effect of buoyancy, and vacated volume would be supplemented by the surrounding liquid which has lower temperature and higher density. When the supplement liquid is also raised up by the effect of buoyancy, the liquid near to the left junction 315 flows to the right junction 316 and back to the bottom of the left zone 311, to initiate a clockwise uni-directional circulating flow.

As nucleic acid amplification takes place, the fluorescent substance, which is loaded into the U-shaped loop, will interact with the amplicon and emit a fluorescent signal when it is excited by the light source. The fluorescence is focused by the lens 34 and then passing through the filter 35 to filter out the non-predetermined wavelengths. In this embodiment, the emitted fluorescence signal with a wavelength 510-530 nm is detected by the CCD 36 and then the optical signals are converted to the electronic signals. The processor 37 analyzes the electronic signals. Therefore, this invention could real-time monitor the product concentration.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A portable apparatus for performing uni-directional convective qPCR or qRT-PCR in a mixing reagent containing a target nucleic acid and a fluorescence dye including denaturation, annealing and extension processes, the apparatus comprises:
an asymmetric circulation-enabling container for containing the mixing reagent with the target nucleic acid and the fluorescence dye for performing uni-directional convective qPCR or qRT-PCR, wherein the asymmetric circulating-enabling container comprises at least one opening, a closed-loop system, and a pathway connected from end to end which allows for the mixing reagent to flow through different zones of the asymmetric circulation-enabling container in one cycle;
a temperature controlling unit comprising a heat source for supplying the heat and a temperature sensor for detecting the status of the heat source, wherein the temperature controlling unit is placed and contacted in a specific region in the asymmetric circulation-enabling container, wherein the mixing reagent near the contacted region of the asymmetric circulation-enabling container is heated first therefore to form a uni-directional circulation because of the buoyancy and gravity difference inside the asymmetric circulation-enabling container;
a light source for exciting the fluorescence dye in the mixing reagent to emit a fluorescent signal when the qPCR or qRT-PCR is initiated, wherein the light source is placed in a specific region;
a photo-detector for converting the fluorescent signal to an electronic signal;
an optical element for directing the fluorescent signal to the photo-detector, wherein the optical element is placed between the asymmetric circulation-enabling container and the photo-detector;
a filter for filtering out a non-predetermined wavelength of the light source, wherein the filter is placed between the optical element and the photo-detector; and
a processor for receiving and analyzing the electronic signal which is detected from the temperature controlling unit and the photo-detector, wherein a programmed algorithm is built in the processor to quantify the PCR or RT-PCR in real-time;
wherein when the temperature of the contacted region of the circulation-enabling container increases to the reaction temperature of denaturation, a uni-directional circulation of the mixing reagent begins and the PCR or RT-PCR reaction is initiated, the temperature sensor of the temperature controlling unit transfers the temperature status to the processor to initiate the light source to excite the fluorescence dye to emit the fluorescent signal, wherein the fluorescent signal is filtered by the optical device and is detected by the photo-detector and converted to the electronic signal and is analyzed by a programmed algorithm the processor to quantify the PCR or RT-PCR products in real-time.

2. The apparatus according to claim 1, wherein the asymmetric circulation-enabling container is a U-shaped loop.

3. The apparatus according to claim 1, wherein the asymmetric circulation-enabling container is a U-shaped loop, wherein the U-shaped loop includes a left zone, a right zone, a link zone and a bottom zone, wherein the link zone is connected from the left zone to the right zone with a asymmetric height.

4. The apparatus according to claim 3, wherein the inner diameter of the U-shaped loop is 0.6 mm to 1.6 mm and the total volume of the mixing reagent contained in the U-shaped loop is 30-150 μl.

5. The apparatus according to claim 4, wherein the circulation speed is about 1.7-6 mm/s.

6. The apparatus according to claim 1, wherein the optical element is a lens or an optical fiber.

7. The apparatus according to claim 1, wherein the photo-detector is a photomultiplier zone, photodiodes, or a photo-detector array.

8. The apparatus according to claim 7, wherein the photo-detector array is a CCD or a CMOS.

9. The apparatus according to claim 1, wherein the light source is LED lights, laser diode lights, or halogen lights.

10. A portable apparatus for performing uni-directional convective qPCR or qRT-PCR in a mixing reagent containing a target nucleic acid and a fluorescence dye including denaturation, annealing and extension processes, the apparatus comprises:
a circulation-enabling container for containing the mixing reagent with the target nucleic acid and the fluorescence dye for performing uni-directional convective qPCR or qRT-PCR, wherein the circulating-enabling container comprises at least one opening, a closed-loop system, and a pathway connected from end to end which allows for the mixing reagent to flow through different zones of the circulation-enabling container in one cycle;
a plurality of temperature controlling units wherein each temperature controlling unit comprises a heat source for supplying the heat and a temperature sensor for detecting the status of the heat source, wherein the plurality of temperature controlling units are placed and contacted in specific regions in the circulation-enabling container, wherein a first temperature controlling unit supplying heat in a lower portion of the circulation-enabling container to reach a relative high temperature region is placed lower in height and a second temperature controlling unit supplying heat in a higher portion of the circulation-enabling container to reach a relative low temperature region is placed higher in height in the circulation-enabling container, wherein the mixing reagent near the first temperature controlling unit reaches a relatively higher temperature than the mixing reagent near the second temperature controlling unit therefore to form a uni-directional circulation because of the buoyancy and gravity difference inside the circulation-enabling container;
a light source for exciting the fluorescence dye in the mixing reagent to emit a fluorescent signal when the qPCR or qRT-PCR is initiated, wherein the light source is placed in a specific region;
a photo-detector for converting the fluorescent signal to an electronic signal;
an optical element for directing the fluorescent signal to the photo-detector, wherein the optical element is placed between the circulation-enabling container and the photo-detector;
a filter for filtering out a non-predetermined wavelength of the light source, wherein the filter is placed between the optical element and the photo-detector; and
a processor for receiving and analyzing the electronic signal which is detected from the temperature controlling unit and the photo-detector, wherein a programmed algorithm is built in the processor to quantify the PCR or RT-PCR in real-time;
wherein when the temperature of the first temperature controlling unit increases to the reaction temperature of denaturation, a uni-directional circulation of the mixing reagent begins and the PCR or RT-PCR reaction is initiated, both the temperature sensors of the first and second temperature controlling units transfer the temperature status to the processor to initiate the light source to excite the fluorescence dye to emit the fluorescent signal, wherein the fluorescent signal is filtered by the optical device and is detected by the photo-detector and converted to the electronic signal and is analyzed by a programmed algorithm the processor to quantify the PCR or RT-PCR products in real-time.

11. The apparatus according to claim 10, wherein the circulation-enabling container is an asymmetric circulation-enabling container or a symmetric circulation-enabling container.

12. The apparatus according to claim 11, wherein the asymmetric circulation-enabling container is a U-shaped loop, wherein the U-shaped loop includes a left zone, a right zone, a link zone and a bottom zone, wherein the link zone is connected from the left zone to the right zone with an asymmetric height.

13. The apparatus according to claim 11, wherein the symmetric circulation-enabling container is a U-shaped loop, wherein the U-shaped loop includes a left zone, a right zone, a link zone and a bottom zone, wherein the link zone is connected from the left zone to the right zone with a symmetric height.

14. The apparatus according to claim 12, wherein the inner diameter of the U-shaped loop is 0.6 mm to 1.6 mm and the total volume of the mixing reagent contained in the U-shaped loop is 30-150 μl.

15. The apparatus according to claim 14, wherein the circulation speed is about 1.7-6 mm/s.

16. The apparatus according to claim 13, wherein the inner diameter of the U-shaped loop is 0.6 mm to 1.6 mm and the total volume of the mixing reagent contained in the U-shaped loop is 30-150 μl.

17. The apparatus according to claim 16, wherein the circulation speed is about 1.7-6 mm/s.

18. The apparatus according to claim 10, wherein the optical element is a lens or an optical fiber.

19. The apparatus according to claim 10, wherein the photo-detector is a photomultiplier zone, photodiodes, or a photo-detector array.

20. The apparatus according to claim 19, wherein the photo-detector array is a CCD or a CMOS.

21. The apparatus according to claim 10, wherein the light source is LED lights, laser diode lights, or halogen lights.
